(19) United States
(12) Patent Application Publication
(10) Pub. No.: US 2006/0259416 A1
(43) Pub. Date: Nov. 16, 2006

(54) Distributed system for securities transactions

(76) Inventor: Garrett Johnson, Virginia Beach, VA (US)

Correspondence Address: WILLIAMS MULLEN, 222 CENTRAL PARK AVENUE, SUITE 1700, VIRGINIA BEACH, VA, 23462-3035, US

(21) Appl. No.: 11/434,670

(22) Filed: May 16, 2006

Related U.S. Application Data
(60) Provisional application No. 60/681,503, filed on May 16, 2005.

(51) Int. Cl. G06Q 40/00

(52) U.S. Cl. 705/37

(57) ABSTRACT

The present invention is a distributed information system that automates the front office function of a traditional stock brokerage, including the ability to register new consumers as clients at an accessible kiosk. Consumers establish cash accounts at the kiosk and undertake securities transactions against a cash account. This system provides a securities trading entry point in the form of user friendly kiosks and the supporting architecture to bring securities trading to a broader segment of the population than traditional brokerages, or direct access trading software applications, which require prior registration and internet access. The kiosks are configured so as to avoid storing personal information of the consumers. The present invention may be used with a computerized back office system, or a traditional back office staff, either in-house or provided by a third party.

### CROSS REFERENCE TO RELATED APPLICATIONS

The present application claims priority from U.S. Provisional Application Ser. No. 60/681,503, filed May 16, 2005.

### FIELD OF THE INVENTION

The present invention relates to a method and system for registering consumers and enabling transactions involving securities.

### BACKGROUND OF THE INVENTION

For traditional investors, stockbrokers act as agents for the buying and selling of stocks, bonds, and other securities. A registered or licensed stockbroker either charges a client a flat fee and/or a commission for making each trade. Typically, a stockbroker collects the orders from the client and facilitates trades using a trading system, which in general may be considered to be any facility, information system, or computer software that provides a mechanism for collecting orders, matching, and executing orders. Various trading systems are generally known to those in the field.

However, stock brokers may be inaccessible or intimidating to many individuals. Traditional brokerage houses may charge hundreds of dollars per dealer assisted trade and an additional fee per share, such as several cents. Discount or direct access trading services have improved the accessibility of trading for individuals by lowering the transaction cost and enabling different ways to conduct transactions, such as over the internet, by automatic teller machines, or via telephone trading directly. These services can offer investors services such as stop orders, purchase or selling of stocks, trading of bulletin board stocks, etc. Some services include optional investment guidance or telephone access to brokers. Notably, remote access to brokerage services requires some initial and conventional registration or account establishment.

For many, however, discount brokerages and direct access trading systems require a financial status (i.e., to make the initial deposit to open an account), level of knowledge (i.e., discount brokers may offer less advice than traditional brokers), and risk affinity similar to traditional brokerages. Although discount brokerages and direct access trading are a significant improvement in availability to consumers, there are still segments of the population that lack cultural or financial accessibility to such brokerages, lack home computers or internet access, have low educational background, or simply do not have the ability to operate a personal computer. Online financial accounts may be out of reach for those of limited means. Such individuals are often in lower paying occupations, and for whom securities investment is unusual. Thus, registration and use of online direct access trading is not available for these individuals, nor are discount brokerages.

Unfortunately, these individuals may be more comfortable purchasing a risky lottery ticket at a convenience store rather than a stock or bond. It is a purpose of the present invention to make registration and direct access available in an approachable and easy to use format, in order to expand the accessibility of securities investments for the benefit of a wider segment of society. In addition, by expanding the accessibility of securities investments, it is an object of the present invention to enable the collection of commissions on such new consumer transaction.

### BRIEF SUMMARY OF THE INVENTION

The present invention is a distributed information system using self registration and service for transactions with publicly traded securities. In particular, a system is established that includes easy to use kiosk style machines in publicly accessible locations and the supporting information systems architecture to replace the front office function of traditional stock brokerages, while automatically collecting commissions on securities transactions.

The front office of a brokerage typically includes the staff, brokers, and traders who deal with the clients, acquire their buy and sell orders, cashier accounts, manage the fulfillment of the orders, and satisfy regulatory requirements. The back office traditionally processed or cleared the trade of securities with such structure as may be desirable or required by the circumstances and applicable regulations.

The present invention automates and distributes the front office functions, including new consumer registration, while the back office may be of any conventional and suitable form. Accordingly, in some embodiments, the back office may involve the use of brokers or representatives, self provided or correspondent contractors who make the actual trades. In other embodiments, the entire system may be automated or structured similarly to direct access trading systems, except that the front office is preferably simplified and distributed to publicly accessible locations, as described herein. Back office functions may thus be considered for the purposes of describing the present invention as a back office network.

As noted above, direct access trading systems enable computer savvy individuals to participate in directing trades, purchases, sales, etc. of securities over the internet at lower costs. However, these trading systems typically require application or registration with the system, significant initial deposits, some degree of computer familiarity and training, and expensive computer equipment; further, the operation of the systems may be somewhat sophisticated, all of which may deter portions of the population from undertaking such transactions. Thus, the “front end” of direct access systems may be as unavailable to some as a traditional brokerage.

Accordingly, the present invention is a consumer-friendly and distributed system that automates the front office functions of a stock brokerage, including the supporting information systems architecture.

### BRIEF DESCRIPTION OF THE SEVERAL VIEWS OF THE DRAWINGS

FIG. 1 is a schematic of the architecture of the present invention.

FIG. 2 is a schematic of an embodiment of a kiosk of present invention.

FIG. 3 is a front external view of a kiosk of an embodiment of the present invention.

FIGS. 4A and 4B are portions of a flow chart of the consumer registration process.

FIG. 5 is an example of a consumer main directory screen.

FIG. 6 is a flow chart of the consumer log in process.

FIG. 7 is a flow chart of the consumer transaction process.

### DETAILED DESCRIPTION OF THE INVENTION

### I. Introduction

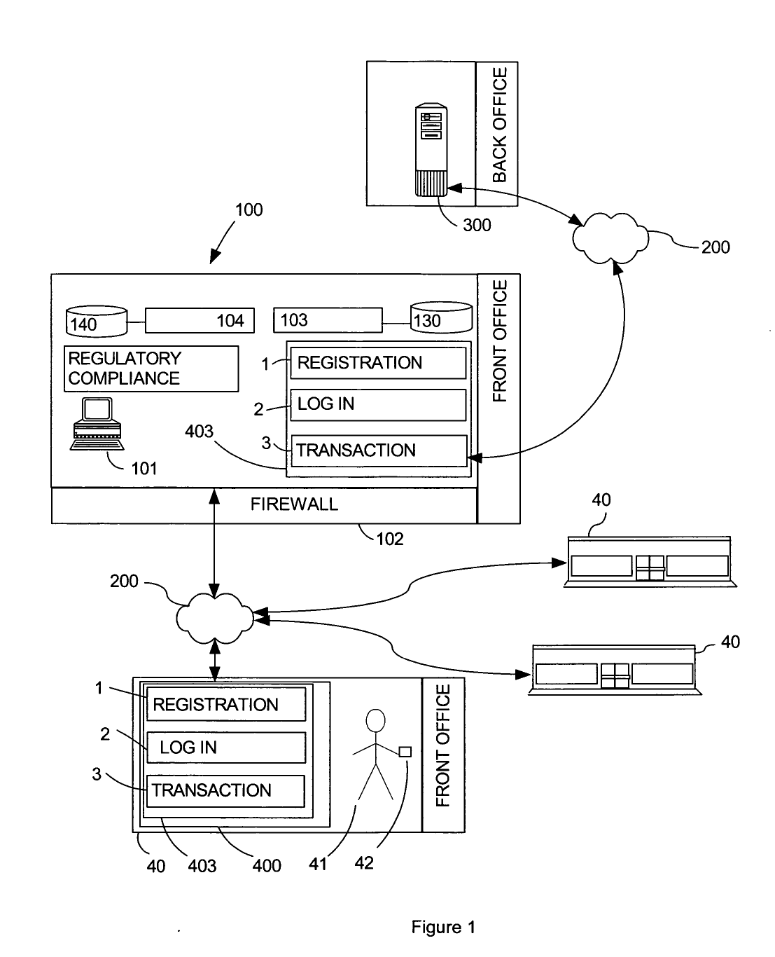

The present invention is a consumer friendly, automated front office for securities trading. A schematic of the system is shown in FIG. 1, and involves central processor system 100, a communication network 200, such as the internet, and at least one distributed securities device or consumer kiosk 400 located in a publicly accessible location, such as retail or entertainment establishment 40. Thus, front office functions are automated between central processor system 100 and kiosk 400. Establishment 40 may include locations such as convenience stores, malls, newspaper stores, transportation terminals, etc. Importantly, the present invention is directed to permitting new consumers 41 to register with the system and enter into or conduct securities transactions.

Central processor system 100 is preferably located in a controllable environment, such as a centralized node to permit remote or distributed inter-relation with kiosks 400 by secure communication through one or more networks 200. Central processor system 100 may include a number of components for such connections to one or more communication networks 200 while supporting kiosks 400; for example, one embodiment of central processor system 100 may include, among other things, at least one of each of the following: controller work station 101 for network administrative functions, gateway server 102 for hosting a firewall, transaction server 103, and regulatory server 104. A plurality of gateway servers 102 and networks 200 may be desirable for security reasons, depending on the application.

A computer software interface application 403 is operatively hosted by transaction server 103 and kiosk 400 in a server-client relationship, respectively, so that transaction server 103 and one or more kiosks 400 communicate and process information for the functions of registration 1, log in 2, and transactions 3; in addition, interface application 403 may include communication and processing functions with central server system 100 for the purposes of regulatory compliance, account management, security management, consumer preferences, commission collection, dividend disbursement, and management of research requests. Information from kiosk 400 is generally sent to central server 100 through a network 200 and gateway server 102. Transaction server 103 also communicates with back office network 300, through network 200 (optionally via an additional gateway server 102) for transactions (e.g., placing or receiving orders, order confirmation, collecting information relating to stocks, market performance, etc., some of which information may be routinely provided to kiosks 400) in response to consumer 41 requests. Back office network 300 and portions of the present invention may rely to some extent on commercially available trading software systems. These components and applications are described for illustration, in that the implementation will depend on the actual application and the features desired.

Optional regulatory server 104 is shown separately as monitoring registrations 1, log in 2, and transactions 3 of kiosks 400 and transaction server 103, and serving federal and state regulatory compliance functions. Such functions may include disclaimers, notice of trading periods, the tendering and recordation of proper notice, record keeping, generation of statements, etc. for compliance with applicable laws, such as securities regulations, financial privacy regulations, tax laws, etc. It is contemplated that such compliance functions will be automatically called by interface application 403 or other software operating on transaction server 103. Gateway server 102 is shown as providing typical network interface functions, including firewall protection and routing, as may be applicable.

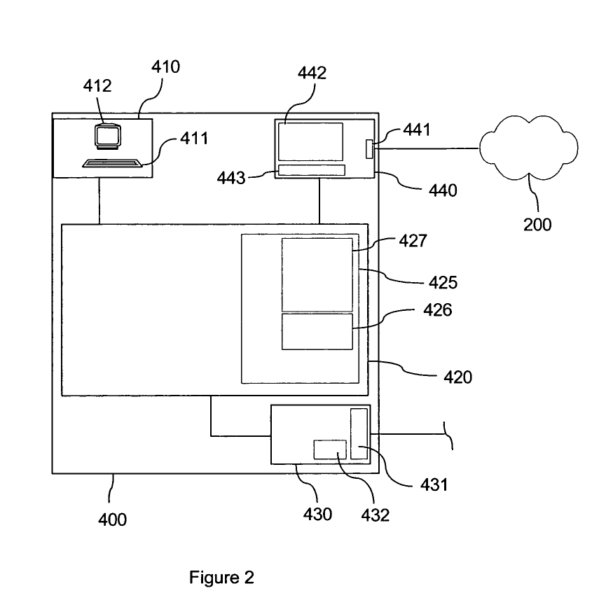

FIG. 2, shows a schematic of an example of kiosk 400. The kiosk 400 includes consumer interface 410, kiosk processor 420 with integrated memory 425, power supply 430, and communications module 440. Power supply 430 preferably includes surge protection 431 and battery backup 432. Integrated storage 425 preferably includes mutable, volatile memory 426 and mutable and immutable non-volatile memory 427; any account or consumer information may be temporarily stored in mutable, volatile memory 426. Account or consumer information is not cached on non-volatile memory 427, and preferably account or consumer information is overwritten during a consumer log out procedure for enhanced security. Consumer interface 410 refers to the hardware with which consumer 41 interacts. Consumer 41 input to consumer interface 410 interacts with interface application 403 (not shown) which, along with any computer software operating system (not shown) for kiosk processor 420, resides in non-volatile memory 427 of integrated storage 425. The interface application 403 preferably offers operational functions in an easy to understand, user friendly environment, while also enabling kiosk 400 to communicate efficiently with central processor system 100. Preferably, consumer interface 410 and interface application 403 will comply with international standards for ergonomic or human factors, such as ISO 9241. In particular, the human machine interface should be highly approachable, effective, efficient, and satisfying, similar to the experience of a mid-range, commonly used video game.

Preferably, communication over network 200 shall use one or more customary forms of enhanced security, such as 128-bit encryption, secure socket layer technology, asynchronous encryption, private keys, etc. In some embodiments, closed or protected networks may not require extensive security measures. In general, communication module 440 will preferably include an integrated firewall 443, a modulator demodulator (modem) 442 adapted to the available communication line, and adaptor 441 for connecting to such communication line. In an alternative embodiment, communication module 440 may support wireless communication technologies, such as satellite or cellular communication. However, wireless communication of financial information should be protected in accordance with industry standards.

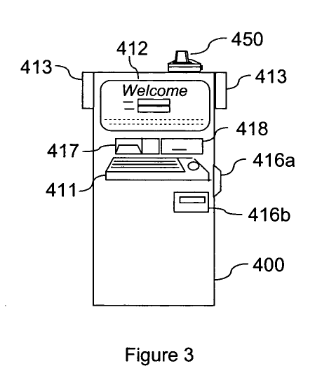

FIG. 3 is an example of an external configuration for a basic and illustrative kiosk 400. In this example, keyboard 411 (with integrated track ball), monitor 412, and speakers 413 provide hardware supporting a basic consumer interface 410. The consumer 41 (not shown) may engage kiosk 400 using keyboard 411 based on instructions provided in monitor 412. Alternatively, monitor 412 may be touch screen, permitting omission of keyboard 411. An optional token reader such as magnetic swipe reader 416a may be provided for reading optional tokens 42 of identity or account ownership, such as magnetic strip cards or smart cards; alternatively, a separate smart card reader 416b may be used for a token reader as well. This embodiment includes the ability to make deposits by one or more deposit devices, such as currency insertion slot 417; alternatively, the deposit device may include credit or debit card readers.

Optional token 42 of account ownership, such as magnetic strip cards, plastic cards, smart cards, etc. may be provided via a token dispenser, such as access door 418 or similar such fixture. Some embodiments may also include printer 450, or a means for dispensing receipts. Those skilled in the art will recognize that RFID tag readers, microphones, cameras, change slots, standard device ports, IR ports, biometric readers, etc. may be incorporated into kiosk 400, depending on the functionality desired and the particular application.

### II. Operation

An illustrative overview of the operation of the present invention may be provided by a brief description of the functioning of interface application 403 with other elements of the present invention for the functions of registration 1, log in 2, and transactions 3. Other functions, such as subsequent orders for sale or purchase, research, changes in preferences, technical assistance, communication, messaging, deposits or withdrawals, provision of related financial services, etc. are contemplated by the present invention but are not described in detail.

Registration 1 may take a wide variety of forms. Upon registration, consumer 41 becomes associated with a unique cash account number and optionally may be issued some token 42 of registration, possibly a storage device, such as a paper contact magnetic strip card, optical card, smart card, or some form of contact-less storage device. Such a storage device would permit the portable retention of information, such as identity, account information, or owner preferences. These cards and devices are available in a wide variety of materials and formats, the choice of which will depend on the embodiment of the present invention, the particular application, the type of account, etc. In addition or as an alternative to a token, the consumer may be issued a personal identification number (PIN) or simply a receipt with an access code. The cash account may be used to make payments during securities transactions.

In some simple embodiments, registration 1 may include a deposit of an acceptable amount of money. In a simple form, the operation of kiosk 400 is somewhat analogous to that of a telephone, bus fare, or metro fare card dispenser. The paper or plastic card in these examples represents ownership of, and access to a prepaid fare. In the present invention, the card or token 42 represents ownership of, and access to, the cash account held within the system. In some cases, token 42 may not include any personally identifying information. Kiosk 400 may thus operate as simple, electronic storage of the money deposited. If such an account were used to purchase securities that fluctuated in value, then the account balance would fluctuate; of course, a cash account would not fluctuate in that way. Generally, however, it may be advisable to limit anonymous accounts to smaller dollar amounts to reduce the effect of theft or loss and for regulatory compliance. In the event that consumer 41 enter instructions to use an anonymous account to purchase securities, compliance with applicable securities and tax laws may require the input of additional personal information.

In contrast to the simple form of registration for anonymous accounts, more involved forms of registration 1 may include the review of multiple types of identification, credit bureau inquiries, privacy and other compliance disclosures, interaction with a representative, etc. As the complexity of registration 1 increases, the security of transactions may be improved; however, an increase in complexity may deter some initial consumers. Accordingly, biometric authentication systems may be desirable for certain embodiments in order to simplify registration 1 while improving the security of transactions. Thus, the form of registration 1 should be tailored to the nature and extent of the account and the corresponding level of trading.

As described above, consumer 41 may register and become associated with a unique account number, either through personal identity or the identity of a token 42, such as a card or portable storage device. Preferably, this association will occur at kiosk 400; however, the association may occur at a separate point of sale, or by some other means of access, such as by a clerk or customer representative, by telephone, or over the internet. In the simple kiosk 400 registration 1 example described above, and in reference to FIG. 3, entry of personal information and a deposit of currency into currency receiver 417 may trigger kiosk 400 to issue token 42 of ownership of a (cash) account number, such as a ticket or magnetic strip card bearing a cash account number provided via access door 418. In that simple, anonymous case, consumer 41 may then take the token 43 to any kiosk 400, enter the account number, possibly by swiping the magnetic strip using magnetic strip reader 416a, and retrieve or access account information or any deposited funds.

Preferably concurrent with registration 1, consumer 41 will deposit funds into the cash account. A minimum balance requirement may be advisable to reduce the administrative burden of frivolous registrations 1 and to enable trades appropriate to the sophistication of the account type. In a simple embodiment, kiosk 400 may provide a deposit device in the same form as a vending or change machine. Optionally, kiosk 400 may provide for the ability to receive funds from credit or debit cards. Further, some embodiments may be capable of telephone or internet transfers of funds into a cash account. Some consumers 41 may desire to build a positive balance over time in preparation for a desired purchase. Others may deposit sufficient funds to begin trading immediately. If a consumer 41 were to change plans, the consumer 41 might withdraw the deposit, possibly less an administrative fee, thereby canceling the account.

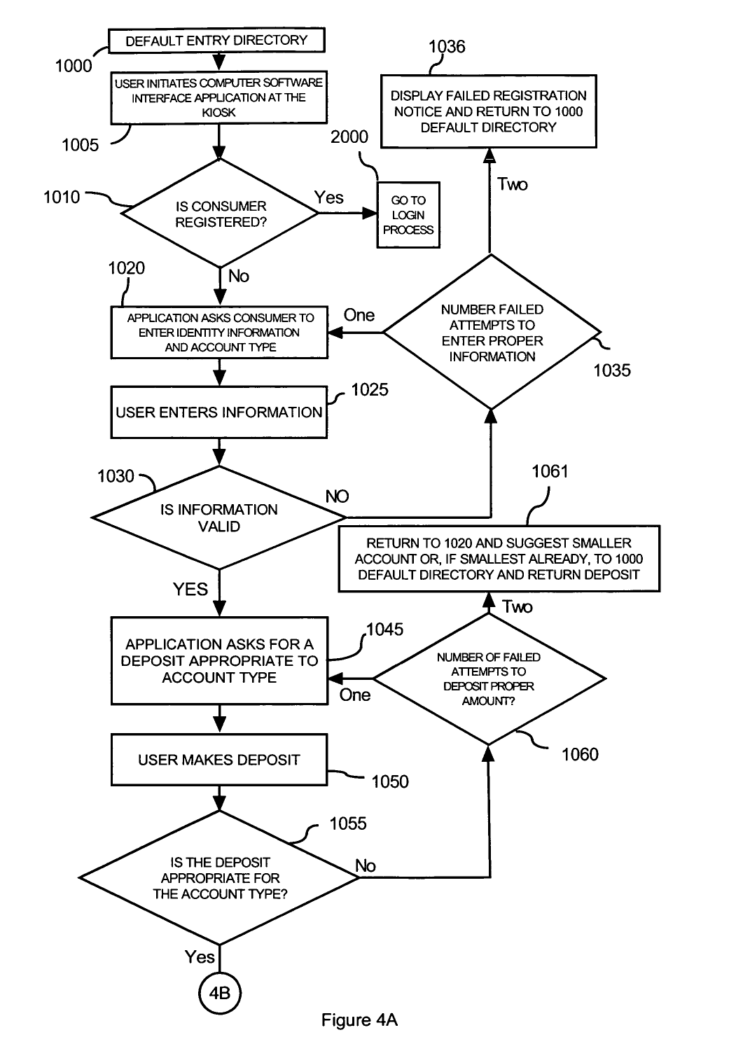

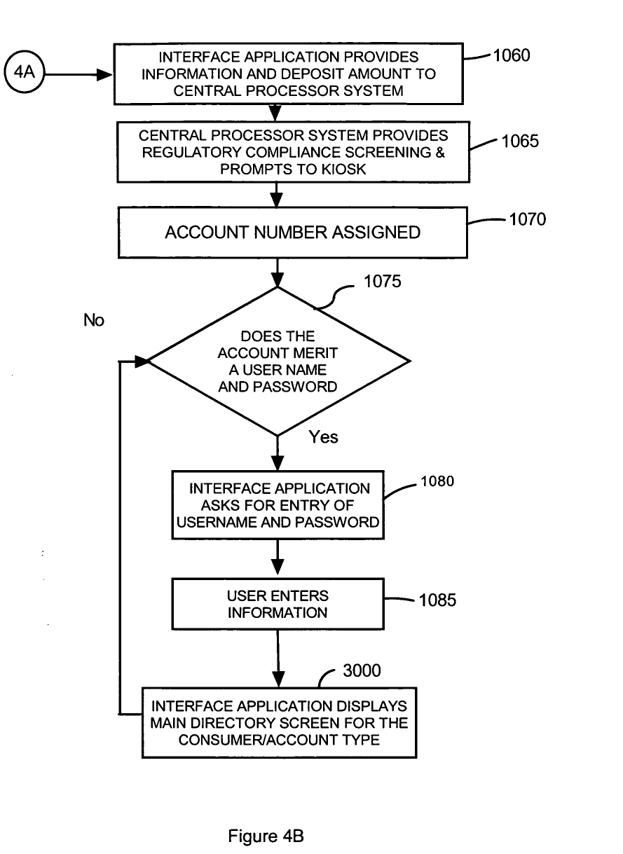

A flow chart for an exemplary process of registration 1 for interface application 403 is shown in FIG. 4. Consumer 41 approaches kiosk 400 (not shown) at interface application 403 default entry directory 1000 and initiates the kiosk interface application, as shown in step 1005. The default directory may be a display describing the utility of kiosk 400 or an attractive screen saver. Initiation may be triggered by touching any keyboard key, moving a track ball, touching the screen, or any other such operation customarily used to “wake up” computer software. Step 1010 is the response, in which the interface application 403 inquires if the consumer 41 is registered or unregistered. New consumers 41 proceed to step 1020, where interface application 403 invites the unregistered consumer 41 to input basic identity information and the type of account desired. As described above, in a preferred embodiment, the present invention will offer a variety of accounts with different levels of service and security. For example, registration 1 in which the total account value is capable of reaching a balance of $5000 might include the input of more information with greater security measures than a registration with a cash account value limited to a balance of $500. The consumer may enter this information, as shown in step 1025, which is then evaluated to determine if it is a valid submission in step 1030. Incorrect information returns the consumer to step 1020 via step 1035. Continued failure to enter valid information may cause the kiosk interface software to return the consumer to the default entry directory, as shown in steps 1035 and 1036. A valid submission is followed by a request for an appropriate initial deposit in step 1045. Such deposits will typically be on a “no less than” basis; the deposit is received in step 1050, and may be in the form of currency, credit, or debit card. The deposit is evaluated in step 1055; deposits that are below a required minimum return the consumer to a request for an additional deposit, as shown in steps 1060. The inability to complete the deposit in a predetermined number of attempts (e.g., 2) returns the new consumer to select a smaller account type (step 1020) or to the default directory if the requested account was the smallest available, as shown in step 1061. Note that if, whether from additional deposits or from stock appreciation, the total account value exceeds the limit for that registration, the system could then prompt consumer 41 to either upgrade the account level (i.e., to enhance the degree of security for the consumer's accounts, along with the exchange of additional consumer information) or to withdraw or transfer stocks or cash.

Once an appropriate deposit is made, then as shown in step 1060, the kiosk interface application transmits the information regarding the consumer and the deposit to central processor system 100 (not shown), for storage in transaction server 103 (not shown) database 130, regulatory server 104 (not shown) database 140, etc. At step 1065, any preliminary regulatory requirements may be satisfied, such as Securities and Exchange Commission (SEC) and National Association of Securities Dealers (NASD) obligations, or Gramm Leach Bliley Act compliance. A unique cash account number is assigned to consumer 41 in step 1070 and, depending on the size of the cash account and/or the total value of the registration, transaction server 103 (not shown) may request a consumer name and password to be provided by the consumer 41, as seen in steps 1075, 1080, and 1085. In some embodiments, biometric scanning or an identification photograph, etc. may be taken at this step. If the amount of initial money within the cash account does not merit a consumer name and password, or if the consumer name and password are acceptable, then the kiosk application displays the consumer's main directory, as shown by step 3000. As described above, a token 42 may be issued for certain accounts.

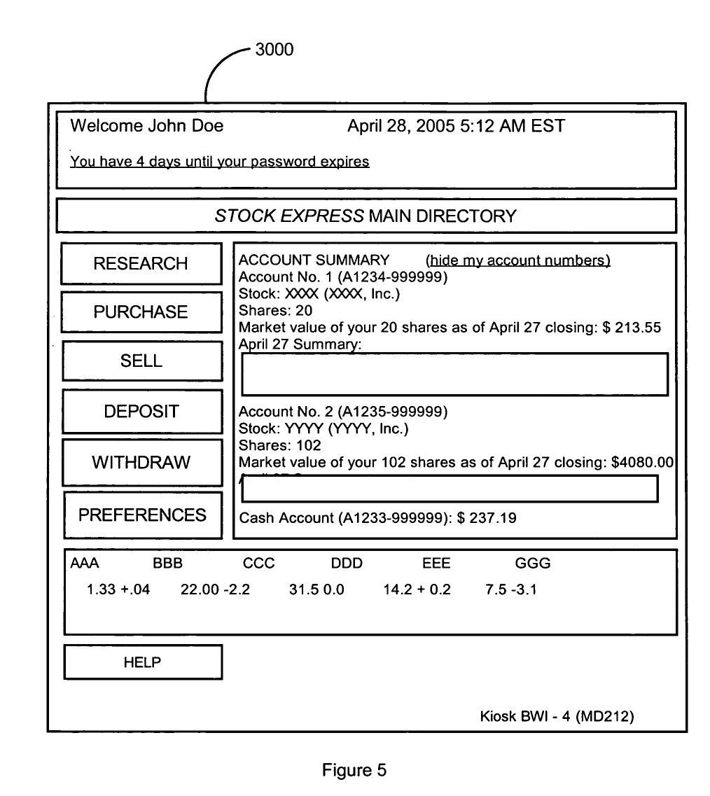

Interface application 403 main directory screen represented in step 3000 may include a wide variety of information. An example of a consumer main directory screen is shown in FIG. 5. The main directory screen may include basic functions and information for consumer 41 to operate interface application 403 at kiosk 400, as supported by the rest of the system. In addition, the main directory may provide announcements and regulatory compliance functions; in essence, the main directory is a primary operations center for interface application 403. Thus, the main directory screen of interface application 403 may take any one of a wide variety of configurations.

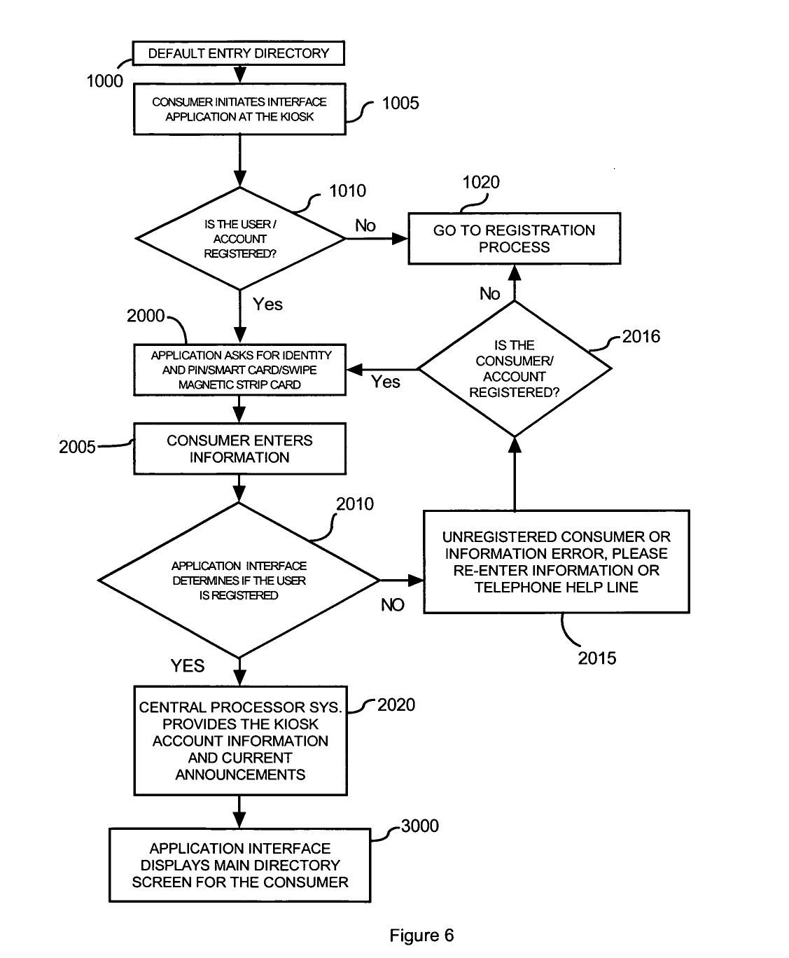

FIG. 6 is a flow diagram of an example of the process for login 2 for interface application 403. A consumer 41 (not shown) approaches kiosk 400 (not shown) showing default entry directory 1000 and initiates the kiosk interface application, as shown in step 1005. In response step 1010, interface application 403 inquires if the consumer 41 is registered or unregistered. New consumers 41 are directed to step 1020 for registration 1, as described above. Registered consumers 41 are prompted in step 2000 for their identity information (or account numbers, for simpler registrations), including password, token 42 scan, or biometric scanning, as applicable. Consumer 41 enters this information in step 2005, which is evaluated in step 2010 by transaction server 103 (not shown) located in central processor system 100 (not shown). If the information from the consumer 41 does not correspond to a registered account, the consumer 41 is directed to registration 1 via steps 2015 and 2016; if the information of the consumer 41 does correspond to a account, but some of the information submitted is missing or incorrect (e.g., such as a mis-spelled entry in a field), then consumer 41 is prompted to supply the correct information in step 2000. If consumer 41 provides correct information, then the appropriate account (i.e., or family of accounts) and related information, such as announcements, are provided to application interface 403 at kiosk 400 by central processor system 100 (not shown) in step 2020. Kiosk 400 (not shown) then displays main directory screen 3000.

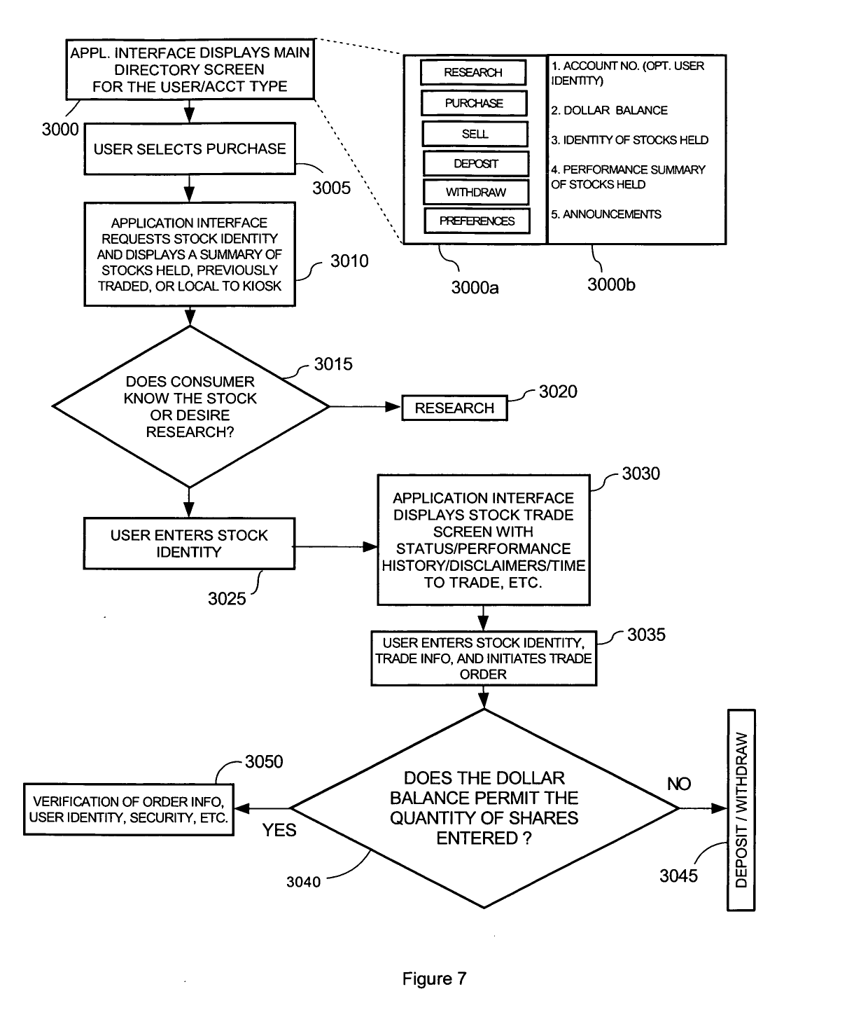

FIG. 7 is a flow diagram of consumer 42 undertaking a transaction 3, such as generating a stock purchase order, beginning from main directory step 3000. Examples of operations suitable for the main directory are shown by 3000a, and examples of information suitable for the main directory are shown by 3000b. Consumer 42 selects a transaction operation (e.g., PURCHASE) from the main directory as shown in step 3005. Interface application 403 requests information concerning the stock identity, optionally displaying information about current holdings or overall market performance, etc., in step 3010. At the same time, by step 3015, consumer 41 is prompted to undertake research (step 3020) if the stock identity or background is unknown. If the consumer 41 knows the stock identity, the consumer 41 may enter its ticker symbol, the full company name, or any other identifier, which action is shown by step 3025. With the stock identity, the interface application 403 may request from transaction server 103 (not shown) and display in step 3030 relevant information about the stock (e.g., share price, P.E. ratio, high and low prices, etc.), performance history, commission percentage or amount, regulatory disclaimers, recent news about the company, approximate time delay to trade, etc. Also in step 3030, consumer 41 is prompted for trade information such as type of purchase, number of shares, source of funds (cash from cash account balance, new deposit, stock sale, etc.) Preferably, this screen may be actively updated; for example, if consumer 41 changes the number of shares, the Net Amount (purchase total with commission) is preferably updated as well. The consumer 41 provides the information in step 3035, which is evaluated in step 3040. Any additional deposit required or excess funds withdrawal may be made at step 3045. Step 3050 designates verification of the order information and confirmation by consumer 41 (i.e., including any security screening, such as a biometric authentication).

With reference to FIG. 1, when an order is verified and issued, the consumer 41 has authorized debit of the cash account and the order is encrypted and transmitted from kiosk 400 (not shown) located within establishment 40 to network 200 by interface application 403. The order is received by central processor system 100 via gateway server 102, and processed in transaction server 103, which is also in communication with back office network 300. Regulatory server 104 may monitor and record the transaction, intervening in the event of any regulatory issue, and automatically generating any required reports. Transaction server 103 may provide the order, along with any funds transfer, regulatory information, etc. to back office network 300. When a transaction 3 is placed by back office network 300 at the appropriate exchange, the back office network 300 sends a confirmation message to consumer 41 via central processor system 100. The stock account of consumer 41 may then be updated or created and main directory 3000 displays a post purchase order placed, pending settlement status. When the transaction is settled, a settlement message may also be sent to consumer 41 and the consumer's account may be updated.

The present invention is adaptable to a wide variety of securities and account types. In general, the more sophisticated trading practices will be suitable for larger, more secure accounts. For example, a margin or short account may not be suitable for a simple, low security account based on a small deposit. However, the present invention could be modified to include the credit investigation and clearance checks of consumers typical with margin or short accounts. On the other hand, a range of securities or types of funds might be made available to a variety of consumers, so long as the required deposit satisfies any fund minimum. In some cases, the present invention may be used to offer factional interests in securities, which could enable access to a wider range of stocks for those of limited means. The present invention may also be adapted for inter-relationship with retirement fund accounts; for example, a retirement fund manager might provide a separate central processor system 100 and account number system, accessible from kiosk 400.

### III. CONCLUSION

The present invention is a distributed information system that automates the front office function of a traditional stock brokerage, including the ability to register new consumers 41. This system provides a securities trading entry point in the form of user friendly kiosks 400 and the supporting architecture to bring securities trading to a broader segment of the population than traditional brokerages, or direct access trading software applications for previously registered users. Notably, kiosks 400 do not retain personal information of consumers 41. The present invention may be used with a computerized back office system, or a traditional back office staff, either in-house or provided by a third party. The above examples should be considered to be exemplary embodiments, and in no way limiting of the present invention. Thus, while the description above refers to particular embodiments, it will be understood that many modifications may be made without departing from the spirit thereof.

What is claimed is:

1. A distributed system for automating front office functions of a brokerage for a plurality of consumers, the system comprising:
a central processor system in communication with a back office network, comprising a transaction server;
a communication network;
one or more kiosks, each kiosk comprising a kiosk processor in communication with the central processor system via the communication network, a kiosk memory in communication with the kiosk processor, a deposit device in communication with the kiosk processor and capable of receiving and verifying currency, credit cards, and debit cards from a consumer; and a consumer interface for receiving information from and communicating information to a consumer;
an interface application having a client software loaded onto the kiosk memory and a server software loaded onto the transaction server, for interrelating operationally between the kiosk processor and the transaction server; and
wherein, the client software is structured to collect information from the consumer, display information to the consumer, provide information to the server software, and to receive and display information from the server software, the server software being structured for receiving information from the client software and providing information to the client software, and further wherein the interface application is operable for performing the functions of registering consumers with new accounts, logging in consumers for access to the interface application and their accounts, and performing consumer directed brokerage transactions involving securities and the consumer accounts.

2. The distributed system of claim 1, wherein the kiosk memory includes volatile and non-volatile memory, and the consumer information is stored on the central server system and not on the non-volatile memory.

3. The distributed system of claim 1, wherein the central processor system further includes a regulatory server operable for the purposes of monitoring operation of the interface application and performing regulatory compliance functions.

4. The distributed system of claim 1, wherein the kiosk further includes a token dispenser and a token reader, for dispensing and reading tokens containing consumer information or account information.

5. The distributed system of claim 1, wherein the securities include mutual funds and factional share accounts.

6. The distributed system of claim 1, wherein the kiosk includes a printer for printing receipts of transactions.

7. The distributed system of claim 1, wherein the central processor system further comprises at least one gateway server for the purpose of a firewall protecting the central server system.

8. The distributed system of claim 1, wherein the function of registering consumers with new accounts includes receiving from the consumer a predetermined dollar amount with the deposit device.

9. The distributed system of claim 1, wherein the central processor system further comprises at least one controller work station for performing network administration functions.
